(19) United States
(12) Patent Application Publication
(10) Pub. No.: US 2019/0289180 A1
(43) Pub. Date: Sep. 19, 2019

(54) IMAGING MODULE AND CIRCUIT BOARD MECHANISM THEREOF

(71) Applicant: O-FILM IMAGE TECHNOLOGY (GUANGZHOU) CO.,LTD., Guangzhou (CN)

(72) Inventor: Wei WANG, NANCHANG (CN)

(73) Assignee: O-FILM IMAGE TECHNOLOGY (GUANGZHOU) CO.,LTD., GUANGZHOU (CN)

(21) Appl. No.: 16/153,638

(22) Filed: Oct. 5, 2018

(30) Foreign Application Priority Data
Mar. 14, 2018 (CN) 201810209481.5

(51) Int. Cl. H04N 5/225; G02B 27/64; H04N 5/232

(52) U.S. Cl. CPC H04N 5/2257; G02B 27/646; H04N 5/2254; H04N 5/23258; H04N 5/2328; H04N 5/2253

(57) ABSTRACT

An imaging module includes a circuit board mechanism, a photosensitive chip located on the circuit board body, a no-board focusing anti-shake component, and a lens located on the no-board focusing anti-shake component. Present disclosure also relates to an imaging module includes a circuit board mechanism comprising a circuit board body and an anti-shake coil located on the circuit board body, a photosensitive chip, a filter, and a lens device located on the circuit board body.

### CROSS-REFERENCE TO RELATED APPLICATION

This application claims the benefit of Chinese Patent Application No. 2018102094815, filed on Mar. 14, 2018, the entire content of which is incorporated herein in its entirety.

### TECHNICAL FIELD

The present disclosure relates to imaging devices, and particularly relates to an imaging module and a circuit board mechanism thereof.

### BACKGROUND

Imaging module is generally provided in a mobile terminal, such as a smartphone, a tablet, and the like. Generally, an imaging module includes a circuit board, a photosensitive chip, a bracket, a filter, a focusing anti-shake component and a lens. The photosensitive chip and the bracket are located on the circuit board. The bracket has a hollow structure with both ends open, and the photosensitive chip is enclosed in the bracket. The filter is located in the bracket, and the lens is located on the focusing anti-shake component to form a lens device of the imaging lens, and the focusing anti-shake component includes a focusing mechanism and an anti-shake mechanism.

The focusing mechanism includes a carrier to mount the lens; an upper clip and a lower clip respectively located on two ends of the carrier (the upper clip and the lower clip are elastically connected to upper end and lower end of the carrier, respectively); a focusing coil wound around an outer wall of the carrier; a housing to receive the carrier, the upper clip, the lower clip, and the focusing coil; a magnet located in the housing, and the magnet is opposite to the focusing coil; and a substrate located on the end of the housing adjacent to the lower clip, the substrate and the housing cooperatively forms a housing of the focusing mechanism. When the focusing coil is electrified, a magnetic field generated by the focusing coil interacts with a magnetic field generated by the magnet, such that the carrier drives the lens to reciprocate along an optical axis of the lens, thereby achieving focusing. When the focusing coil is de-electrified, the carrier returns to its initial position due to the elasticity of the upper and the lower clips.

The anti-shake mechanism includes a circuit board, an anti-shake coil, and a suspension wire. The circuit board is located in the housing and is located on the substrate, and the circuit board is electrically connected to the circuit board of the imaging module. The anti-shake coil is located on the circuit board, one end of the suspension wire is connected to the circuit board, and another end is connected to the upper clip, such that the carrier is suspended in the housing, and the focusing coil is electrically connected to the circuit board body sequentially through the upper clip and the suspension wire. When the gyroscope on the circuit board senses a shaking, the carrier configured to mount the lens slightly moves in a plane perpendicular to the optical axis. At this time, a driving chip on the circuit board controls the anti-shake coil to be electrified, the magnetic field generated by the anti-shake coil interacts with the magnetic field of the magnet, such that the carrier makes an opposite displacement in the plane perpendicular to the optical axis to compensate a shaking displacement, thereby obtaining photos with high quality. When the anti-shake coil is de-electrified, the suspension wire drives the carrier back to its initial position.

An imaging module with both focusing and anti-shake function can achieve a good photographic effect, but it generally has a relatively large size, which is not suitable for the trend of developing thinner and miniaturized mobile terminals, therefore the application of this imaging module on a mobile terminal is limited.

### SUMMARY

According to various embodiments of present disclosure, an imaging module and a circuit board mechanism thereof are provided.

A circuit board mechanism includes a circuit board body to carry a photosensitive chip of an imaging module, and the circuit board mechanism further includes an anti-shake coil located on the circuit board body.

An imaging module includes a circuit board mechanism including a circuit board body and an anti-shake coil located on the circuit board body, a photosensitive chip, a filter, and a lens device located on the circuit board body.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a perspective view of an imaging module according to an embodiment.

FIG. 2 is an exploded, perspective view of the imaging module of FIG. 1.

FIG. 3 is a rear, perspective view of the imaging module of FIG. 1.

FIG. 4 is a perspective view of the circuit board mechanism of FIG. 1.

FIG. 5 is an exploded view of a lens device of FIG. 1.

FIG. 6 is a perspective view of a carrier of FIG. 5.

FIG. 7 is a rear, perspective view of the carrier of FIG. 6.

FIG. 8 is a perspective view of an anti-shake frame of FIG. 5.

FIG. 9 is a rear perspective view of the anti-shake frame of FIG. 8.

FIG. 10 is a perspective view of a lower clip of FIG. 5.

FIG. 11 is an exploded, perspective view of an upper clip of FIG. 5.

### DETAILED DESCRIPTION OF THE EMBODIMENTS

The imaging module is further described hereinafter with reference to the accompanying drawings and specific embodiments.

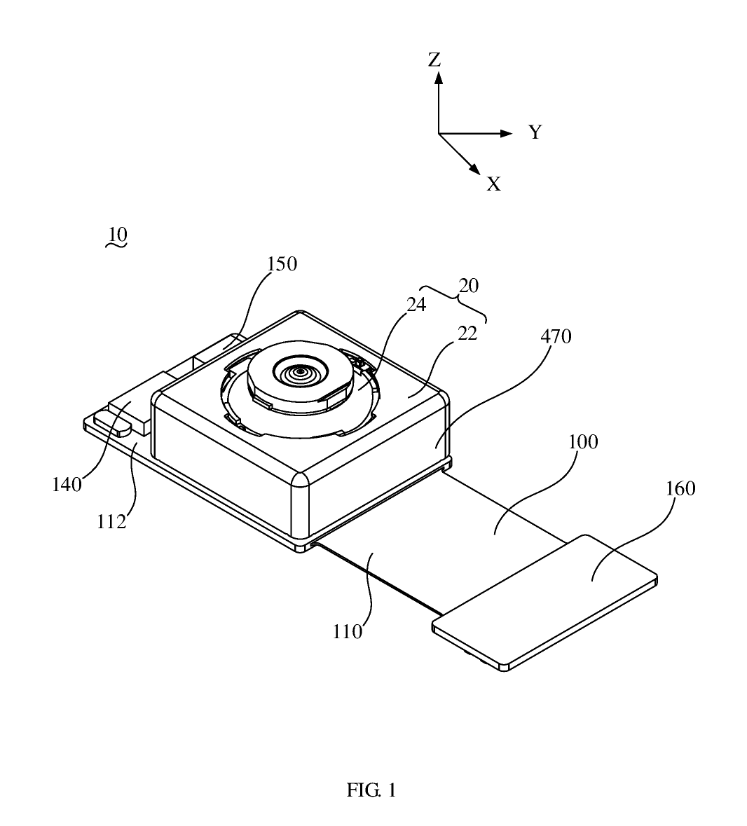

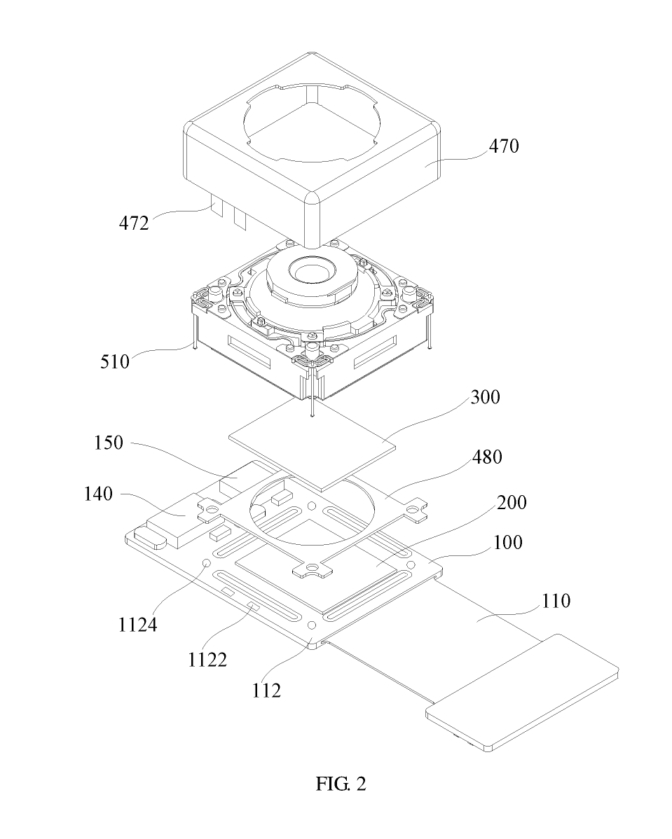

Referring to FIG. 1 and FIG. 2, an imaging module 10 according to an embodiment can be applied in a mobile terminal such as a smartphone or a tablet. Specifically, the imaging module 10 is an integrated imaging module.

The imaging lens 10 includes a circuit board mechanism 100, a photosensitive chip 200, a filter 300, and a lens device 20. The circuit board mechanism 100 is used to carry the photosensitive chip 200, the filter 300, and the lens device 20. The photosensitive chip 200 is located on the circuit board mechanism 100. The lens device 20 includes a housing 470, which is directly located on the circuit board mechanism 100. The photosensitive chip 200 and the filter 300 are both located in the housing 470, and the filter 300 is connected to the housing 470, and the filter 300 is spaced apart from the photosensitive chip 200.

In a conventional imaging module, it is necessary to employ a bracket provided between the circuit board mechanism and the lens device, the filter is located in the bracket, and the lens device is located in an end surface of the bracket away from the circuit board mechanism. In the contrast, according to the illustrated embodiment, the housing 470 of the lens device 20 is directly located on the circuit board mechanism 100, and the photosensitive chip 200 and the filter 300 are both located in the housing 470, such that the conventional bracket of the imaging module can be omitted, so as to achieve a thinner integrated imaging module 10. Comparing to the conventional imaging module, the integrated imaging module 10 has a better stress strength.

Additionally, in the illustrated embodiment, the lens device 20 further includes a substrate 480, which is located in an end of the housing 470 adjacent to the circuit board mechanism 100. The filter 300 is located on a surface of the substrate 480 away from the circuit board mechanism 100, such that the filter is easy to be assembled. It should be understood that, in alternative embodiments, the filter 300 can be directly connected to an inner wall of the housing 470, as long as the substrate 480 is omitted.

Furthermore, in the illustrated embodiment, the housing 470 is provided with a connecting pin 472 located on a bottom housing adjacent to the circuit board body 110, an alignment hole 1122 corresponding to the connecting pin 472 is defined on the first surface 112 of the circuit board mechanism 100, and the connecting pin 472 is inserted into the alignment hole 1122. Therefore, it is easy to assemble the housing 470 on the circuit board mechanism 100.

Moreover, in the illustrated embodiment, the connecting pin 472 is fixed to an inner wall of the alignment hole 1122. Therefore, the housing 470 can be firmly connected to the circuit board mechanism 100. Furthermore, in an embodiment, a conductive adhesive layer (not shown) is provided between the inner wall of the alignment hole 1122 and the connecting pin 472. In this way, a formation of a conductive bump on the surface of the circuit board mechanism 100 can be avoided, therefore no conductive bump will occupy an inner room of the housing 470. Specifically, a bonding layer (not shown) can be provided between the housing 470 and the circuit board mechanism 100, such that the connection between the housing 470 and the circuit board mechanism 100 is more firm.

The lens device 20 can be a fixed-focus lens device, and can also be an auto-focus lens device, or a focusing anti-shake lens device. Specifically, in the illustrated embodiment, the lens device 20 includes a no-board focusing anti-shake component 22 and a lens 24 located in the no-board focusing anti-shake component 22. The housing 470 of the lens device 20 is also a housing of the no-board focusing anti-shake component 22.

In a conventional imaging module, the lens device is located on the bracket carrying the filter, an element in the focusing anti-shake component that needs to be electrified is conductive to the external circuit board mechanism via a circuit board in the focusing anti-shake component, and a ground wire of the circuit board is connected to a ground wire of the circuit board mechanism. Since the housing of the lens device of the conventional imaging lens is not grounded, the imaging module cannot shield external electromagnetic interference well.

To address the aforementioned problem, in the illustrated embodiment, the housing 470 is conductive, and the connecting pin 472 is a conductive pin electrically connected to the circuit board mechanism 100. The housing 470 is grounded via the connecting pin 472, such that the imaging module 10 can shield the external electromagnetic interference. Specifically, in the illustrated embodiment, the housing 470 is an iron box, and two pins 472 are provided.

It is to be noted that, the method of shielding electromagnetic interference via grounding the housing 470 can not only be applied to the no-board focusing anti-shake component according to the embodiment, but can also be applied to a conventional fixed-focus lens device, an auto-focus lens device, and a focusing anti-shake lens device provided with a circuit board.

The circuit board mechanism 100 and no-board focusing anti-shake component 22 is further described hereinafter. The photosensitive chip 200 and the no-board focusing anti-shake component 22 are electrically connected to a main board of the mobile terminal via the circuit board mechanism 100.

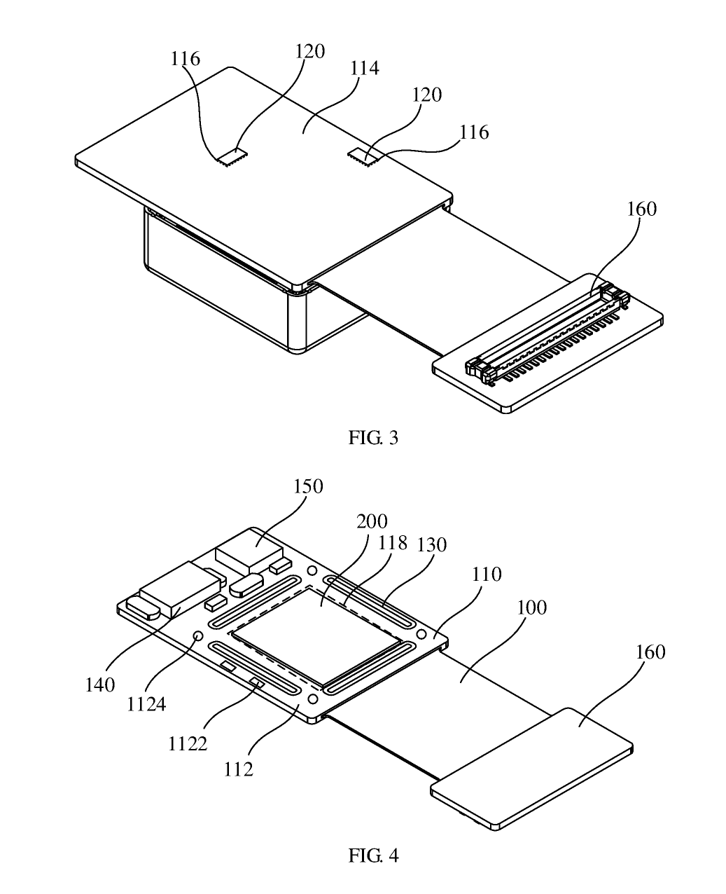

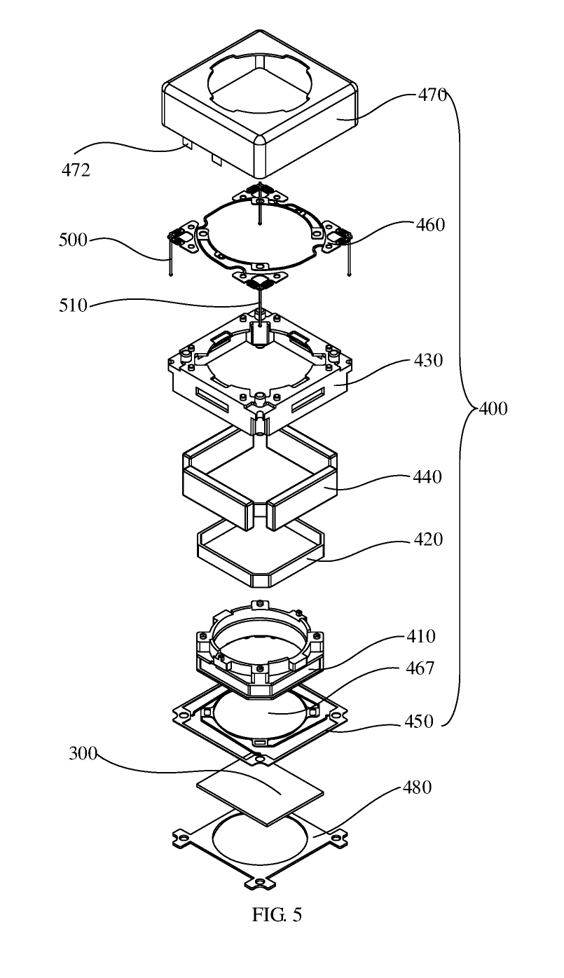

Referring to FIG. 3 and FIG. 4, the circuit board mechanism 100 includes a circuit board body 110, a Hall sensor 120, an anti-shake coil 130, a gyroscope 140, a driving chip 150, and a connector 160.

The circuit board body 110 includes a first surface 112 and a second surface 114 opposite to each other. The first surface 112 is used to carry the photosensitive chip 200. The second surface 114 defines a mounting groove 116, and the Hall sensor 120 is received in the mounting groove 116, and is used to detect a displacement of a magnet 440 of the lens device 20.

A focusing anti-shake component of the conventional imaging module is provided with the built-in circuit board mechanism, and the circuit board mechanism includes the circuit board and the Hall sensor and the anti-shake coil. To reduce the room of the focusing anti-shake component occupied by the circuit board mechanism, and to achieve a thinner focusing anti-shake component, generally a circuit board with less thickness is applied. However, due to a height of the Hall sensor, a height of the area of the circuit board mechanism provided with the Hall sensor is greater than or equal to a the height of the Hall sensor, therefore a relatively large room of the focusing anti-shake component is occupied by the circuit board mechanism, which is disadvantageous to achieve a thinner focusing anti-shake component.

To address the problem of the circuit board mechanism occupying a large room of the focusing anti-shake component, in the illustrated embodiment, the Hall sensor 120 is moved from the focusing anti-shake component to the outside of the focusing anti-shake component, therefore the height of the circuit board mechanism 100 is not limited by the height of the Hall sensor 120, so as to achieve a thinner no-board focusing anti-shake component 22.

Since the circuit board body 110 is required to carry the photosensitive chip 200, the filter 300, a focusing mechanism 400, and an anti-shake mechanism 500, a thickness of the circuit board body 110 is relatively large. The mounting groove 116 defined on the second surface 114 can receive at least a portion of the Hall sensor 120, thereby reducing a height of an area of the circuit board mechanism 100 provided with the Hall sensor 120, and further reducing a height of the overall imaging module 10.

More specifically, in the illustrated embodiment, an end surface of the Hall sensor 120 away from the first surface 112 is coplanar with the second surface 114. In other words, the Hall sensor 120 is completely embedded in the circuit board body 110, thereby further reducing the height of the area of the circuit board mechanism 100 provided with the Hall sensor 120. According to other embodiments, the end surface of the Hall sensor 120 away from the first surface 112 is protruded from the second surface 114, in this way, an avoiding recess can be defined on the mobile terminal for the Hall sensor 120, so as to prevent the protruded Hall sensor 120 from affecting the overall height of the imaging module assembled on the mobile terminal.

In alternative embodiments, the Hall sensor 120 can also be located on the second surface 114.

In the illustrated embodiment, the Hall sensor 120 is aligned with the anti-shake coil 130. Specifically, the first surface 112 includes a chip mounting area 118 to carry the photosensitive chip 200. An orthographic projection of the anti-shake coil 130 on the first surface 112 is located on the outer edge of the chip mounting area 118. Similarly, an orthographic projection of the Hall sensor 120 on the first surface 112 is located on the outer edge of the chip mounting area 118.

The anti-shake coil 130 is located on the first surface 112. A magnetic field generated by the electrified anti-shake coil 130 is used to interact with a magnetic field generated by the magnet 440, such that the lens device 20 of the imaging module 10 makes an opposite displacement in the plane perpendicular to the optical axis (axis Z) to compensate a shaking displacement, thereby achieving an anti-shake effect.

A conventional focusing anti-shake component of the imaging module is provided with a built-in circuit board mechanism, which includes a circuit board, a Hall sensor and an anti-shake coil located on the circuit board. The built-in circuit board mechanism will occupy the space of the focusing anti-shake component, which is not conducive to achieve a thinner focusing anti-shake component. To address the aforementioned defects, in the illustrated embodiment, the Hall sensor 120 and the anti-shake coil 130 are located on different surfaces of the circuit board body 110, thus the circuit board integrated in the conventional focusing anti-shake component can be omitted, thereby achieving a thinner no-board focusing anti-shake component.

Specifically, in the illustrated embodiment, a plurality of the anti-shake coils 130 are provided, and the anti-shake coils 130 are provided around the chip mounting area 118. More specifically, in the illustrated embodiment, the photosensitive chip 200 is square in shape, and thus the chip mounting area 118 is also square. The number of the anti-shake coils 130 is four, and the four anti-shake coils 130 are corresponding to four edges of the chip mounting area 118, respectively. The number of the Hall sensor 120 is two, and the two Hall sensors 120 are aligned with two adjacent anti-shake coils 130, respectively.

Moreover, in the illustrated embodiment, the Hall sensor 120 and the anti-shake coil 130 are mounted on the circuit board body 110 via a SMT (Surface Mount Technology) process. In this way, the number of the welding process can be reduced.

The gyroscope 140 and the driving chip 150 are both located on the first surface 112. The gyroscope 140 is used to sense a shake of imaging module 10, and the driving chip 150 is used to electrify the anti-shake coil 130 when the shake of the imaging module 10 is sensed by the gyroscope 140. In the illustrated embodiment, the gyroscope 140 is used to sense a displacement (shaking amount) of the lens device 20 at a plane (plane XY) perpendicular to the optical axis, i.e. the gyroscope 140 is configured to sense a displacement (shaking amount) of the magnet 440 at the plane (plane XY) perpendicular to the optical axis. In this way, when the driving chip 150 electrifies the anti-shake coil 130, and the shaking displacement is compensated, the Hall sensor 120 can be used to determine whether the compensated shaking displacement is correct via sensing the displacement of the magnet 440.

Specifically, in the illustrated embodiment, the gyroscope 140 and the driving chip 150 are located on the same end of the circuit board body 110. In this way, the structure of the circuit board mechanism 100 is more reasonable and compact. It should be understood that, in alternative embodiments, the gyroscope 140 can be omitted.

In the illustrated embodiment, the connector 160 is located on one end of the circuit board body 110 away from the gyroscope 140, and the connector 160 is electrically connected to the main board of the mobile terminal. In this way, the structure of the circuit board mechanism 100 is more reasonable and compact.

Referring to FIG. 5, the no-board focusing anti-shake component 22 includes a focusing mechanism 400 and an anti-shake mechanism 500.

The focusing mechanism 400 includes a carrier 410, a focusing coil 420, an anti-shake frame 430, four magnets 440, a lower clip 450, an upper clip 460, the housing 470 and the substrate 480. The carrier 410 is used to hold the lens 24, the focusing coil 420 is wound around an outer wall of the carrier 410, and the focusing coil 420 and the carrier 410 are located in the anti-shake frame 430. The magnets 440 are located in the anti-shake frame 430 and between the focusing frame 430 and the carrier 410, and the magnet 440 is aligned with the focusing coil 420 and the anti-shake coil 130, respectively. Outer rings of the upper clip 460 and the lower clip 450 are connected to the upper end and the lower end of the anti-shake frame 430, respectively. Inner rings of the upper clip 460 and the lower clip 450 are elastically connected to the upper end and the lower end of the carrier 410, respectively, and the upper clip 460 is electrically connected to the focusing coil 420. The anti-shake frame 430, the upper clip 460 and the lower clip 450 are all located in the housing 470. The substrate 480 is located on the end of the housing 470 adjacent to the lower clip 450. In the illustrated embodiment, the anti-shake frame 430 is configured to facilitate the assembly of the upper clip 460 and the lower clip 450. It should be understood that, in alternative embodiments, the anti-shake frame 430 can be omitted. In this case, the carrier 410, the focusing coil 420, the upper clip 460, the lower clip 450, and the magnets 440 are all located in the housing 470.

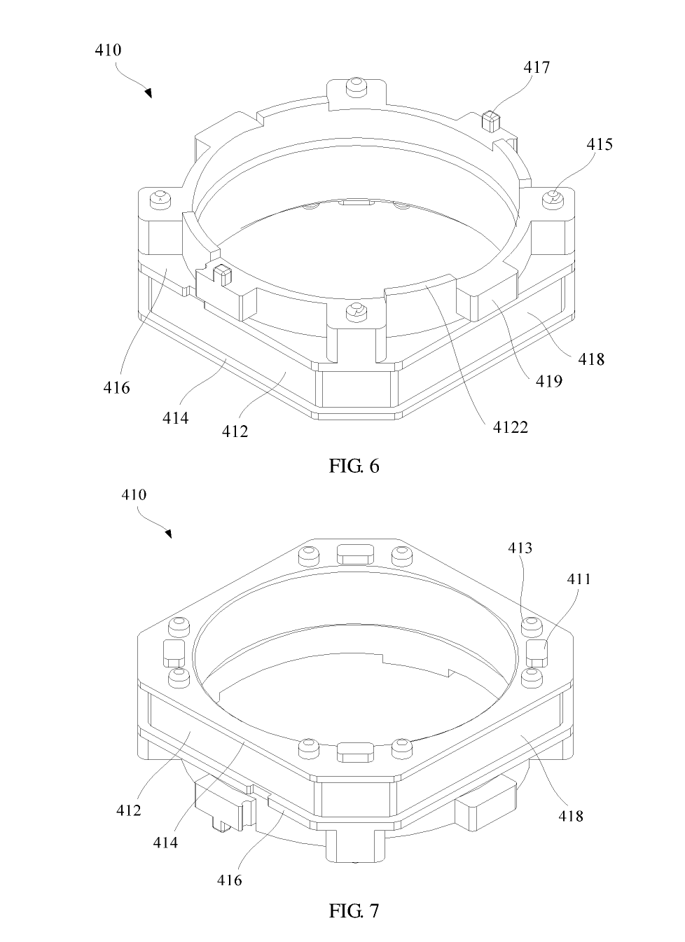

Additionally, referring to FIG. 6 and FIG. 7, in the illustrated embodiment, the carrier 410 includes a barrel 412, a lower ring plate 414 and an upper ring plate 416. The barrel 412 is used to mount the lens 24. The lower ring plate 414 and the upper ring plate 416 are both located on the barrel 412, and the lower ring plate 414 and the upper ring plate 416 cooperatively form a latching recess 418, and the focusing coil 420 is located in the latching recess 418. Specifically, in the illustrated embodiment, the lower ring plate 414 is located on a lower end surface of the barrel 412, and the upper ring plate 416 sleeves on the barrel 412. An upper end surface of the barrel 412 is provided with a protrusion 4122.

Additionally, in the illustrated embodiment, the lower end surface of the carrier 410 is provided with a lower positioning post 411 and first limiting posts 413 located on both sides of the positioning post 411. A conductive post 415 and an upper positioning post 417 are located on an upper end surface of the carrier 410, and the conductive post 415 is electrically connected to the focusing coil 420. Specifically, in the illustrated embodiment, the carrier 410 further includes a mounting block 419 located on a surface of the upper ring plate 416 away from the lower ring plate 414. An end surface the mounting block 419 is coplanar with the upper end of the barrel 412, the conductive post 415 and the upper positioning post 417 are located on the upper end surface of the mounting block 419. More specifically, in the illustrated embodiment, a plurality of the mounting blocks 419 are provided, and the mounting blocks 419 are spacedly arranged. The protrusion 4122 is located between two adjacent mounting blocks 419. Some of the mounting blocks 419 are provided with the conductive post 415 or the upper positioning post 417, while the rest of the mounting blocks 419 are not.

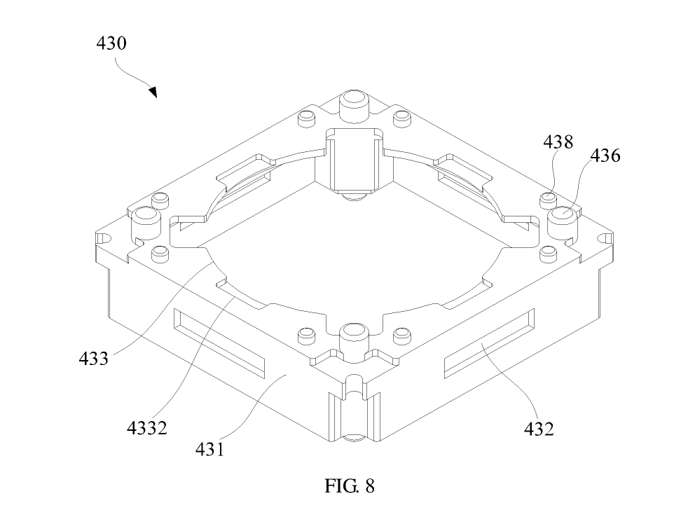

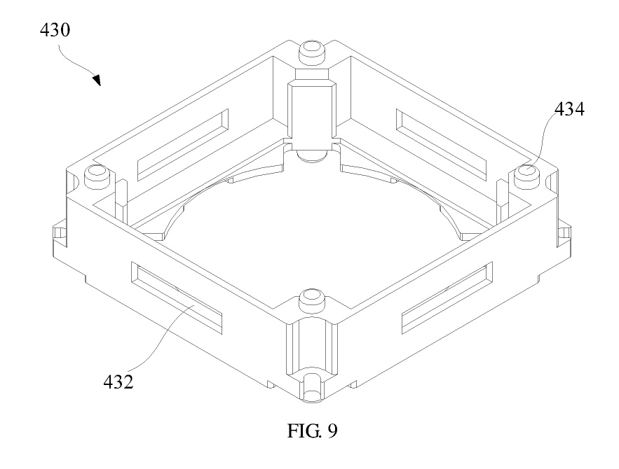

Referring to FIG. 8 and FIG. 9, the magnet 440 is located on an inner wall of the anti-shake frame 430, a side wall of the anti-shake frame 430 defines four through holes 432 corresponding to the four magnets 440, such that each magnet 440 can be exposed from the through hole 432. The through hole 432 on the inner wall of the anti-shake frame 430 can facilitate the interaction between the magnetic field of the magnet 440 and the magnetic field generated by the electrified anti-shake coil 130, and it can also facilitate reducing the weight of the anti-shake frame 430, so as to achieve a thinner and lighter focusing mechanism 400. Specifically, in the illustrated embodiment, the anti-shake frame 430 is square, and the four magnets 440 are respectively located on four side walls of the anti-shake frame 430, and the four magnets 440 are aligned with the anti-shake coil 130, respectively.

A first positioning post 434 is located on the lower end surface of the anti-shake frame 430, and a second positioning post 436 and second limiting posts 438 located on two sides thereof are located on the upper end surface of the anti-shake frame 430. Specifically, in illustrated embodiment, the anti-shake frame 430 includes a frame body 431 with both ends open and a ring plate 433 located on the upper end of the frame body 431, and the second post 436 and the second limiting post 438 are located on an upper surface of the ring plate 433. An inner wall of the ring plate 433 introverts to form a limiting recess 4332 corresponding to the mounting block 419, and the mounting block 419 is latched in the limiting recess 4332. In this way, the carrier 410 can be firmly secured to the anti-shake frame 430.

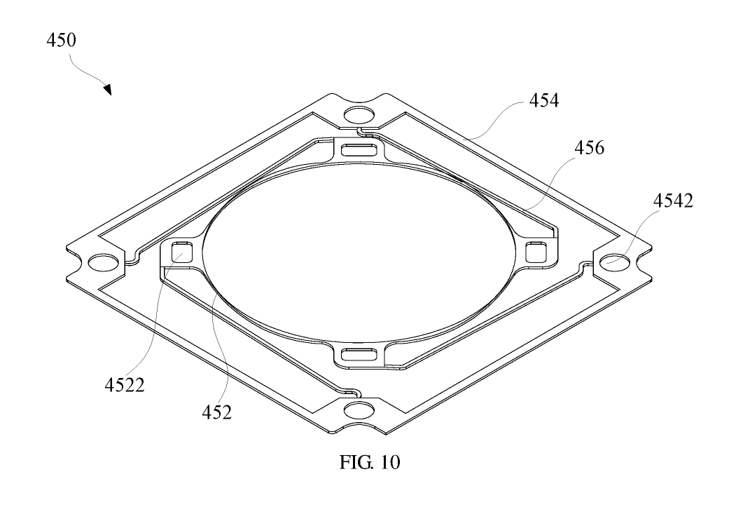

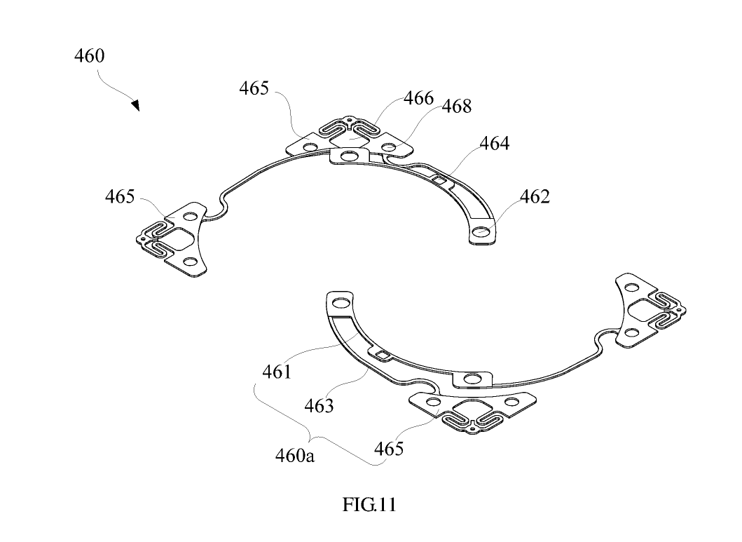

Referring to FIG. 10, the lower clip 450 includes an inner ring 452, an outer ring 454, and a cantilever 456 connecting the inner ring 452 and the outer ring 454. The inner ring 542 of the lower clip 450 defines a lower position through hole 4522 corresponding to the lower positioning post 411, and the lower positioning post 411 inserts through the lower position through hole 4522, and the first limiting post 413 is located between the inner ring 452 and the cantilever 456. The outer ring 454 of the lower clip 450 defines a first position through hole 4542 corresponding to the first positioning post 434, and the first position 434 inserts through the first position through hole 4542.

Referring to FIG. 11, the upper clip 460 defines a conductive through hole 462 corresponding to the conductive post 415, a upper position through hole 464 corresponding to the upper positioning post 436, and a second limiting through hole 468 corresponding to the second limiting post 438. The conductive post 415 inserts through the upper limiting through hole 464, the second positioning post 436 inserts through the second position through hole 466, and the second limiting post 438 inserts through the second limiting through hole 468.

Additionally, in the illustrated embodiment, the upper clip 460 includes two spaced half clips 460a, the two half clips 460a cooperatively form an aperture 467, and the lens 24 inserts through the aperture 467. In this way, the breakage and damage of the upper elastic piece 460 due to a large stress can be avoided. The half clip 460a includes an inner arc section 461, an outer arc section 463 and two connecting portions 465, the two connecting portions 465 are respectively connected to one end of the inner arc section 461 and the outer arc section 463, a free end of the inner arc section 461 is connected to a free end of the outer arc section 463, and the inner arc section 461 abuts against the protrusion 4122 of the carrier 410. The conductive through hole 462 and the upper position through hole 464 are defined on the inner arc section 461, and the second position through hole 466 and the second limiting through hole 468 are defined on the connecting portion 465.

Additionally, in the illustrated embodiment, the four connecting portions 465 of the two half clips 460a form four corners of the upper clip 460. In the way, on the premise that the inner ring and the outer ring of the upper clip 460 are respectively connected to the carrier 410 and the anti-shake frame 430, the imaging lens 10 can be thinner and lighter. Specifically, in the illustrated embodiment, the upper clip 460 is substantially square.

It should be noted that, in the permanent magnetic field of the magnet 440, an amount of expansion and contraction of the lower clip 450 and the upper clip 460 can be controlled via changing the current in the anti-shake coil 130, so as to drive the lens 24 to reciprocate along the direction of the optical axis back to achieve focusing.

Referring to FIG. 2 and FIG. 5, the anti-shake mechanism 500 includes a suspension wire 510, the suspension wire 510 extends through the substrate 480 and the lower clip 450. One end of the suspension wire 510 is electrically connected to the circuit board body 110, and the other end is electrically connected to the upper clip 460, such that the anti-shake frame 430 is suspended in the housing 470, and the focusing coil 420 is electrically connected to the circuit board body 110 sequentially through the upper clip 460 and the suspension wire 510.

Specifically, in the illustrated embodiment, the substrate 480, the lower clip 450 and the anti-shake frame 430 each form a notch to avoid the suspension wire 510, i.e., the suspension wire 510 is not in contact with the substrate 480, the lower clip 450, and the anti-shake frame 430. One end of the suspension wire 510 extends through the connecting portion 465 of the upper clip 460, and is electrically connected to the connecting portion 465. A number of the suspension wires 510 is identical to a number of the connecting portions 465 of the upper clip 465.

Additionally, in the illustrated embodiment, the first surface 112 of the circuit board body 110 defines a connecting hole 1124, the end of the suspension wire 510 away from the upper clip 460 is inserted into the connecting hole, and the end is also electrically connected to the circuit board body 110. Defining the connecting hole 1124 can not only facilitate electrically connecting the suspension wire 510 and the circuit board body 110, but also facilitate positioning and mounting the suspension wire 510 on the circuit board body 110.

Additionally, in the illustrated embodiment, each of the half clips 460a is connected to two suspension wires 510.

In the aforementioned imaging module 10, compared to a conventional imaging module, two brackets and one circuit board mechanism located in the focusing anti-shake component are omitted, therefore the aforementioned imaging module 10 is thinner and lighter.

The technical features of the embodiments described above can be arbitrarily combined. In order to make the description succinct, there is no describing of all possible combinations of the various technical features in the foregoing embodiments. It should be noted that there is no contradiction in the combination of these technical features which should be considered as the scope of the description.

Although the present disclosure is illustrated and described herein with reference to specific embodiments, the present disclosure is not intended to be limited to the details shown. It is to be noted that, various modifications may be made in the details within the scope and range of equivalents of the claims and without departing from the present disclosure. Therefore, the protection scope of the present disclosure shall be subject to the protection scope of the claims.

What is claimed is:

1. A circuit board mechanism, comprising:
a circuit board body configured to carry a photosensitive chip of an imaging module, and
an anti-shake coil located on the circuit board body.

2. The circuit board mechanism according to claim 1, further comprising a Hall sensor located on the circuit board body, wherein the Hall sensor is configured to detect a displacement of a magnet of the imaging module.

3. The circuit board mechanism according to claim 2, wherein the circuit board body comprises a opposed first and second surfaces, the first surface is configured to carry the photosensitive chip of the imaging module, the anti-shake coil is located on the first surface, and the second surface defines a mounting groove, the Hall sensor is at least partially received in the mounting groove.

4. The circuit board mechanism according to claim 3, wherein an end surface of the Hall sensor away from the first surface is coplanar with the second surface.

5. The circuit board mechanism according to claim 3, wherein the first surface comprises a chip mounting area configured to carry the photosensitive chip, the number of anti-shake coils is plural, and the plurality of anti-shake coils are arranged around the chip mounting area.

6. The circuit board mechanism according to claim 5, wherein the chip mounting area is in square shape, the number of the anti-shake coils is four, and four anti-shake coils correspond to four edges of the chip mounting area, respectively; and the number of the Hall sensor is two, and two Hall sensors are aligned with two adjacent anti-shake coils, respectively.

7. The circuit board mechanism according to claim 3, further comprising a gyroscope and a driving chip located on the first surface, wherein the gyroscope is configured to sense a shake of imaging module, and the driving chip is configured to charge the anti-shake coil in response to determining that the gyroscope senses a shake of the imaging module.

8. The circuit board mechanism according to claim 7, further comprising a connector located on an end of the circuit board body, wherein the gyroscope and the driving chip are located on the end of the circuit board body away from the connector, and the anti-shake coil and the Hall sensor are located between the connector and the gyroscope.

9. An imaging module, comprising:
a circuit board mechanism comprising a circuit board body and an anti-shake coil located on the circuit board body;
a photosensitive chip, a filter, and a lens device located on the circuit board body.

10. The imaging module according to claim 9, wherein the lens device comprises:
a housing located on the circuit board body;
a no-board focusing anti-shake component connected to the circuit board body; and
a lens located in the no-board focusing anti-shake component;
wherein the photosensitive chip and the filter are located in the housing.

11. The imaging module according to claim 10, wherein the lens device further comprises a substrate located on a bottom of the housing adjacent to the circuit board body, and the filter is located on a surface of the substrate away from the circuit board mechanism.

12. The imaging module according to claim 10, wherein the housing is provided with a connecting pin located on a bottom thereof adjacent to the circuit board body, the circuit board body comprises a opposed first and second surfaces, the first surface defines an alignment hole corresponding to the connecting pin, and the connecting pin is inserted into the alignment hole.

13. The imaging module according to claim 12, wherein the housing is conductive and is grounded via the connecting pin.

14. The imaging module according to claim 10, wherein the no-board focusing anti-shake component comprises:
a carrier configured to mount the lens;
a focusing coil wound around an outer wall of the carrier;
a magnet located in the housing and aligned with the focusing coil;
a lower clip and a upper clip, wherein inner rings of the upper clip and the lower clip are elastically connected to upper end and lower end respectively; and
a suspension wire, wherein an end of the suspension wire is electrically connected to the circuit board body, and another end is electrically connected to the upper clip, such that the carrier is suspended in the cover, and the focusing coil is electrically connected to the circuit board body sequentially through the upper clip and the suspension wire.

15. The imaging module according to claim 14, wherein the upper clip comprises two spaced half clips, the two half clips cooperatively form an aperture, and the lens extends through the aperture.

16. The imaging module according to claim 14, wherein the no-board focusing anti-shake component further comprises an anti-shake frame located in the housing, the focusing coil and the carrier are located in the anti-shake frame, the magnet is located in the anti-shake frame and located between the focusing frame and the carrier, and outer rings of the upper clip and the lower clip are connected to an upper end and a lower end of the anti-shake frame, respectively.

17. The imaging module according to claim 16, wherein a side wall of the anti-shake frame defines a through hole aligned with the magnet, such that the magnet is exposed through the through hole.
